(19) United States
(12) Patent Application Publication
(10) Pub. No.: US 2006/0145673 A1
(43) Pub. Date: Jul. 6, 2006

(54) Method and apparatus for reducing inrush current to a voltage regulating circuit

(76) Inventors: John Kenneth Fogg, Cary, NC (US); Robert Clifton Walker, Chapel Hill, NC (US); Warren Richard Schroeder, Fuquay Varina, NC (US)

Correspondence Address: COATS & BENNETT, PLLC, P O BOX 5, RALEIGH, NC, 27602, US

(21) Appl. No.: 11/028,120

(22) Filed: Jan. 3, 2005

(51) Int. Cl. G05F 1/40; G05F 1/618

(52) U.S. Cl. 323/282

(57) ABSTRACT

A voltage regulating circuit, such as a voltage regulator or battery charger, limits inrush current by buffering an associated supply input decoupling capacitor through a current path that is selectively configured to have a high impedance for startup charging of the decoupling capacitor at a low current, and a low impedance for normal operations of the circuit. Where the circuit uses multiple supply input connections for operation from two or more supply voltages, it may include buffering for each one of two or more supply input connections. It may further include a crossover switching control circuit that ensures make-before-break switching between supply input connections to avoid supply interruptions to the circuit during switchover.

### BACKGROUND OF THE INVENTION

The present invention generally relates to voltage regulating circuits, such as voltage regulator Integrated Circuits (ICs), battery charger ICs, etc., and particularly relates to limiting the inrush current associated with such devices.

Most types of voltage regulating circuits, such as voltage regulators and battery chargers, use input supply decoupling capacitors to “decouple” the device from the input voltage supply. In such roles, the decoupling capacitors act as local charge reservoirs capable of sinking and sourcing transient current as needed, in response to supply voltage fluctuations and/or fluctuations in the operating current drawn by the device.

One recurring disadvantage attending the use of input decoupling capacitors is their tendency to cause a relatively high inrush current when voltage is first applied to the supply input of a device. The high current results from the-application of the supply voltage to the uncharged decoupling capacitors, and itself can result in transient voltage ringing (with potentially significant overshoot) at the device's input. In fact, the voltage overshoot problem is potentially severe, since the device's internal circuits generally must be capable of surviving the peak ringing voltages.

Ideally, the input capacitance would be minimized to reduce or eliminate the inrush current associated with device startup. However, minimizing the input capacitance works at cross purposes with providing effective decoupling. That is, a given application requires enough input capacitance for sufficient decoupling performance, and that amount of input capacitance generally is large enough to be problematic with respect to high inrush currents.

### SUMMARY OF THE INVENTION

The present invention comprises a method and apparatus wherein a voltage regulating circuit, such as a battery charging circuit, includes features that limit its inrush current without compromising its input supply decoupling. Broadly, a method of limiting inrush current into a voltage regulating circuit comprises coupling a supply input connection of the voltage regulating circuit to a decoupling capacitor connection of the voltage regulating circuit through a current path that is selectively changeable from a high-impedance condition to a low-impedance condition. Inrush current thus can be limited by maintaining the current path in its high-impedance condition until the decoupling capacitor is sufficiently charged, at which point the current path can be changed to its low-impedance condition to thereby allow the voltage regulating circuit to draw the current needed for normal operation.

Thus, in one embodiment, the present invention comprises a method of limiting inrush current into a voltage regulating circuit comprising buffering a decoupling capacitor connection of the voltage regulating circuit from a supply input connection of the voltage regulating circuit through a current path that is selectively changeable from a high-impedance condition to a low-impedance condition responsive to determining whether a decoupling capacitor associated with the decoupling capacitor connection is charged. Detecting the decoupling capacitor charge may be based on detecting a voltage level of the decoupling capacitor.

With the above method, any input decoupling capacitors associated with the voltage regulating circuit generally are not electrically connected to the circuit's supply voltage through a low impedance path until they are at least partially charged. In an exemplary embodiment, then, the voltage regulating circuit includes a supply input connection coupled to a decoupling capacitor connection through a current path, and a startup control circuit configured to limit inrush current to the voltage regulating circuit.

The exemplary startup control circuit can be configured to carry out a method whereby it changes the current path from a high-impedance condition to a low-impedance condition responsive to detecting a defined voltage level at the decoupling capacitor connection. It may, for example, accomplish the high-to-low impedance change by changing a variable resistance circuit device from a high resistance to a low resistance. Controlling the turn-on voltage of a pass transistor is one example of this type of control mechanism. Selectively turning on a low-impedance current path that is in parallel with a high-impedance current path is another example of a control mechanism that effects the high-to-low change in current path impedance.

The present invention contemplates the advantageous use of an output capacitor associated with the voltage regulating circuit as the input supply decoupling capacitor for the circuit. That is, the present invention contemplates in one or more of its embodiments making the decoupling capacitor connection the same connection that is used for connecting to the output load of the voltage regulating circuit.

Further, the present invention also can be extended to voltage regulating circuits having two or more supply input connections, whereby inrush current from different voltage supplies is limited accordingly. In one embodiment, each supply input connection is coupled to a decoupling capacitor connection through a current path that can be selectively changed from a high impedance to a low impedance—the same or different decoupling capacitor connections can be used for each supply input connection.

All of the current paths can be configured to have an initially high impedance, for example, such that the application of supply voltage to any of the supply input connections provides a limited charging current for the decoupling capacitor(s) associated with the voltage regulating circuit. After the decoupling capacitors are sufficiently charged, the current path corresponding to the selected one of the supply input connections can be transitioned to the low-impedance condition to allow normal operation of the voltage regulating circuit's primary operating circuits.

As a further feature in an embodiment of the present invention that uses multiple supply input connections, the voltage regulating circuit is configured to include a crossover switching control circuit that switches between supply inputs in a manner that avoids disrupting operation of the voltage regulating circuit, avoids inrush current problems according to the methods outlined above, and reduces or eliminates unintended current flow between the supply input connections, as might otherwise arise if different voltages are applied to the different supply input connections.

Supporting the above exemplary crossover control methods, the crossover switching control circuit may be configured to carry out a make-before-break input supply switching method. For example, the crossover switching control circuit can be configured to selectively change from a currently selected one of first and second supply input connections to a newly selected one of the first and second supply input connections based on placing the current path corresponding to the newly selected supply input connection in a low-impedance condition before placing the current path corresponding to the currently selected supply input connection in a high-impedance condition. After making the change, the crossover switching control circuit may then place the current path corresponding to previously selected supply input connection in the high-impedance condition to prevent current flow from the newly selected supply input connection to the previously selected supply input connection.

The crossover switching control circuit can be configured to switch between supply input connections responsive to detecting voltage levels at the supply input connections, responsive to input commands, responsive to internally configured selection information—e.g., default supply input connection designations, timed schedules, etc. Regardless, the exemplary crossover switching control circuit allows the voltage regulating circuit to be “hot swapped” between different power supplies without disrupting operation of the voltage regulating circuit, and without causing inrush current problems.

As for the advantageous non-disruption of the voltage regulating circuit's operations during hot-swapping, it should be noted that, even without the inclusion of a crossover switching control circuit, the present invention provides at least a small current during startup conditions—i.e., at times when the decoupling capacitors are considered to be discharged—that can be used to keep “alive” low-power circuits that may be included within the voltage regulating circuit. For example, the primary operating circuit may include timers, counters, registers, and other low-power circuit elements, the contents of which may be preserved by the small amount of current that is permitted to flow through the buffering current path, or paths, when they are in their high-impedance condition.

For example, the startup control circuit (as well as “core” logic circuits, such as timers, counters, etc.) may be configured to operate from the relatively low current provided by a high impedance path to the supply input connection, and a portion of that current can serve as a charging current for the decoupling capacitor. The startup control circuit can be configured to activate, or otherwise enable, the main voltage regulating circuits after the decoupling capacitor is charged to a defined level, which may be sensed by detecting the voltage level of the decoupling capacitor. In this context, “activate” may connote asserting a reset control signal, or other type of gating signal, in conjunction with enabling a low-impedance current path to the supply input, so that the primary voltage regulating circuits-the “operating” circuits-are provided with sufficient operating current.

Of course, the present invention is not limited to the features and advantages highlighted in the above summary. Those skilled in the art will recognize additional features and advantages upon reading the following discussion, and upon viewing the accompanying drawings.

### BRIEF DESCRIPTION OF THE DRAWINGS

FIG. 1 is a diagram of an exemplary voltage regulating circuit according to one or more embodiments of the present invention.

FIG. 2 is diagram of exemplary high/low impedance processing/control logic that can be advantageously implemented in the circuit of FIG. 1, for example, to limit inrush current.

FIG. 3 is a diagram of exemplary circuit details for one embodiment of a voltage regulating circuit according to the present invention.

FIG. 4 is a diagram of exemplary circuit details for another embodiment of a voltage regulating circuit according to the present invention.

FIGS. 5A and 5B are diagrams of exemplary crossover processing/control logic that may be advantageously implemented in the circuit of FIG. 4, for example.

FIG. 6 is a diagram of exemplary circuit details for another embodiment of a voltage regulating circuit according to the present invention.

### DETAILED DESCRIPTION OF THE INVENTION

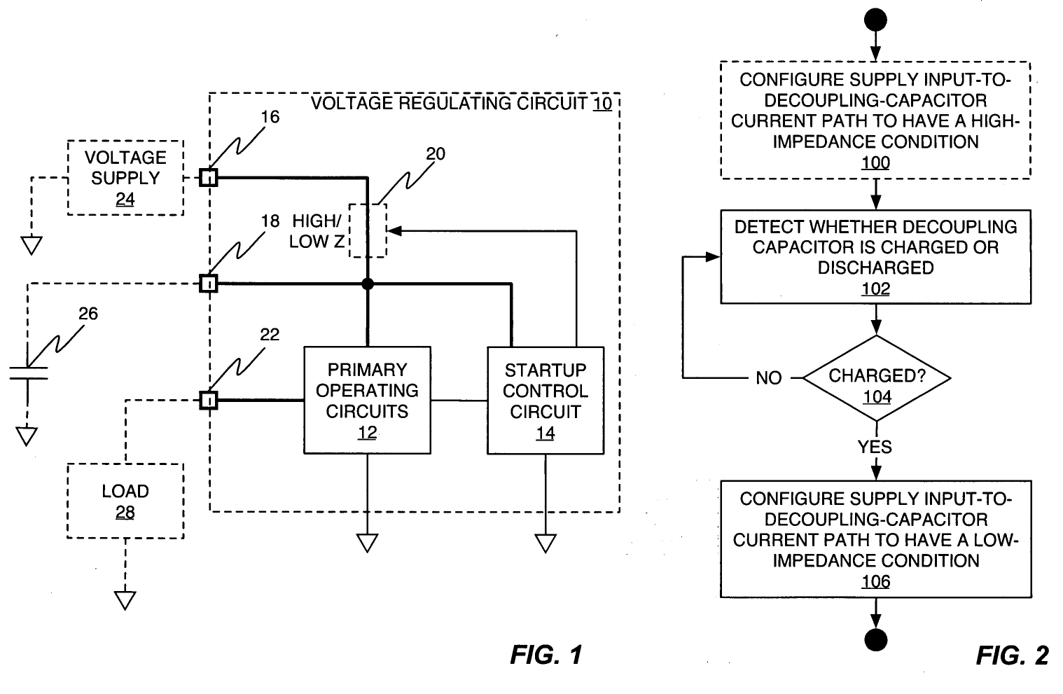

FIG. 1 is a diagram of an exemplary voltage regulating circuit 10. As used herein, the term “voltage regulating circuit” is given broad meaning and, by way of non-limiting examples, encompasses voltage regulators—such as linear or switching voltage regulators—and battery charging circuits that provide regulated output voltage and/or regulated output current to a battery, and possibly to an associated load. Those skilled in the art will appreciate that such circuits commonly are implemented as Integrated Circuit (IC) devices, and the present contemplates one or more embodiments wherein a voltage regulating IC incorporates the inrush current limiting and the optional crossover switching control disclosed and claimed herein.

With the above broad circuit definition in mind, an exemplary circuit 10 comprises primary operating circuit(s) 12, a startup control circuit 14, a supply input connection 16 coupled to a decoupling capacitor connection 18 through a current path 20, and an output signal connection 22. In a typical application of circuit 10, the supply input connection 16 is coupled to a voltage supply 24, the decoupling capacitor connection 18 is coupled to one or more decoupling capacitors 26, and the output connection 22 is coupled to a load 28, which may comprise one or more circuits powered by a regulated output voltage (or current) provided by the primary operating circuits 12. By way of non-limiting examples, the load may be a music player, a cellular telephone, a pocket computer, etc., and/or may be a battery to be charged.

Current path 20, which itself actually may comprise two or more parallel current paths, is configurable to have a high-impedance condition and a low-impedance condition. In exemplary operation, current path 20 is configured selectively to have a high impedance or a low impedance. Current path 20 generally has a relatively high impedance for startup conditions, which may be defined based on the discharged condition of the decoupling capacitor 26. Conversely, current path 20 generally has a relatively low impedance for normal running conditions, wherein the decoupling capacitor 26 is charged and the primary operating circuit(s) 12 of voltage regulating circuit 10 are drawing normal operating current for carrying out their intended function.

The above configurable path impedance initially buffers the supply voltage coupled to supply input connection 16 from the decoupling capacitors 26, but does not interfere with the ability of circuit 10 to draw normal operating current. This method differs from conventional approaches to supply decoupling, wherein input decoupling capacitor(s) are placed directly on a supply input connection. That approach yields good decoupling performance because of the low-impedance (direct) connection between the voltage supply and decoupling capacitors. However, the conventional approach results in potentially severe voltage ringing at the supply input connection because of the high inrush currents that arise when a discharged capacitor is connected to a stiff voltage supply.

According to the present invention, then, circuit 10 avoids such problems by eliminating (or greatly reducing) inrush current based on buffering the decoupling capacitor connection 18 from the supply input connection 16 through current path 20, which can comprise one or more current paths, as noted above. More particularly, current path 20 is configured to be selectively changeable from a high-impedance condition to a low-impedance condition. In that manner, the current path 20 can be maintained at a high impedance until the voltage regulating circuit 10 detects that the decoupling capacitor 26 has charged to a level sufficient to permit enabling a higher current flow from the voltage supply 24.

Thus, the high-impedance condition limits the current drawn from the voltage supply 24 and, while that current generally is too low to permit primary circuit operations, it is sufficient to charge the decoupling capacitor 26 until it reaches a charge level at which the current path 20 can be changed to a low-impedance condition without causing an inrush current surge. To that end, circuit 10 can include a startup control circuit 14, which operates at low power—i.e., it is operable using a portion of the current drawn from supply 24 while the current path 20 is in the high-impedance condition. In one or more embodiments, the startup control circuit 14 is configured to detect whether the decoupling capacitor(s) 26 are charged or discharged.

Startup control circuit 14 thus can be configured to change the current path 20 from the high-impedance condition to the low-impedance condition responsive to detecting that the associated decoupling capacitor(s) 26 have charged to a defined level. In at least one embodiment, the startup control circuit 14 senses the decoupling capacitor voltage present on a node connected to the decoupling capacitor input 18, and changes the current path 20 from a high-impedance condition to a low-impedance condition responsive to detecting that the sensed voltage has reached a defined level.

FIG. 2 illustrates processing/control logic implemented in circuit 10 in one or more embodiments of the present invention. In particular, some or all of the illustrated processing/control logic is implemented in startup control circuit 14 in at least some embodiments of the present invention. To that end, in one or more embodiments, startup control circuit 14 comprises hardware circuits, such as one or more comparators and voltage references, that are configured to assert one or more control signals responsive to detecting a charged condition of the associated decoupling capacitor 26. Those skilled in the art will recognize other implementation choices, such as where startup control circuit includes programmable logic, or is embodied in computer program instructions for execution by a low-power microprocessor, or other type of digital processing circuit.

In any case, the illustrated processing/control logic “begins” with configuring the current path 20 to have a high impedance (Step 100). Note that this “step” may not represent an active process step in that the current path 20 can be configured to have a high impedance by default, such that an active control step is required to change from a default high-impedance condition to a desired low-impedance condition.

Processing “continues” with voltage regulating circuit 10 detecting whether the decoupling capacitor 26 is charged or discharged (Step 102). Note that as used in this context, it should be understood that voltage regulating circuit 10 generally will not begin “detecting” the charging voltage of the decoupling capacitor 26 until sufficient input voltage is applied to its supply input connection 16 and startup control circuit 14 begins operation.

In any case, assuming that some voltage is applied to supply input 16, and that startup control circuit 14 is operative to detect the charging voltage, startup control circuit 14 preferably is configured to leave the current path 20 in a high-impedance condition until a desired charging voltage level is detected (Step 104). At that point, startup control circuit 14 preferably is configured to change the current path 20 from the high-impedance condition to a low-impedance condition (Step 106). It should be understood that the low-impedance condition is not necessarily a minimal impedance condition, and the actual impedance of the current path 20 may be varied or controlled as needed according to the desired functionality of the primary operating circuit(s) 12. Thus, as used herein, the term “low-impedance condition” does not necessarily connote some static impedance value, but rather connotes some possibly varying impedance value that is considerably lower than the “high” impedance of path 20 that is characteristic of the high-impedance condition.

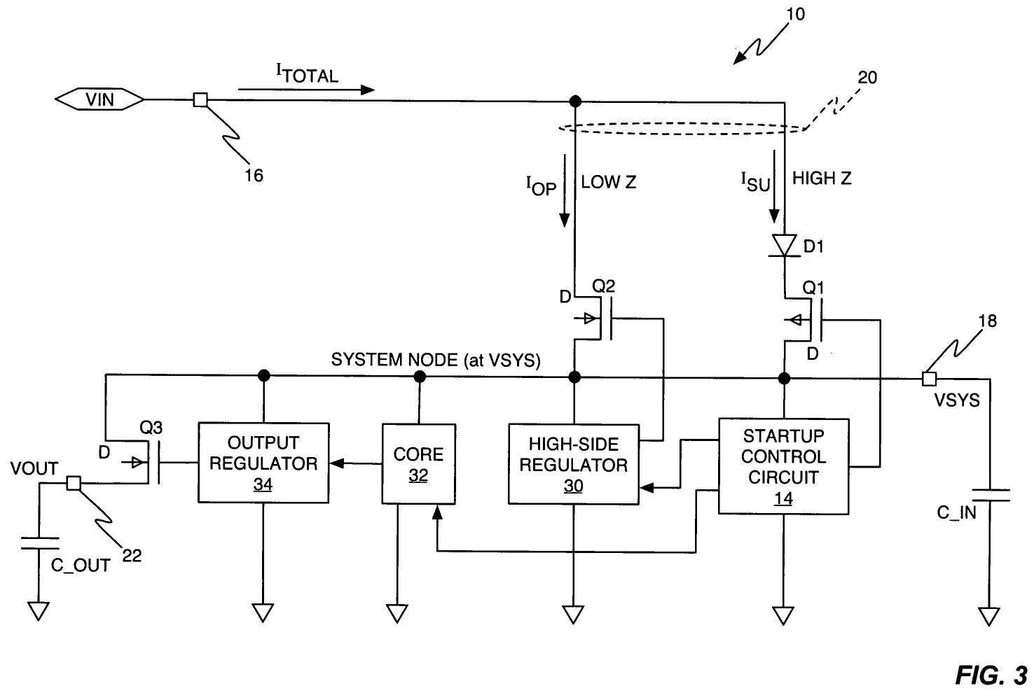

Regardless, transitioning the current path 20 to a low-impedance condition provides operating current to the primary operating circuits 12, and thus allows their operation, possibly subject to a “gating” or reset signal output by the startup control circuit. Such processing/control logic may be better understood in the context provided by FIG. 3, which provides exemplary circuit details for one or more embodiments of the voltage regulating circuit 10.

According to the illustrated configuration, the current path 20 comprises parallel current paths, one having a high impedance and one having a low impedance. The high impedance path includes diode D1 and transistor device Q1, and the low impedance path includes transistor device Q2. Further, the primary operating circuits 12 comprise a high-side regulator 30, an operating “core” (e.g., timers, counters, and other regulating and/or charging logic), an output regulator 34, and an output “pass” transistor device Q3. The pass transistor device Q3 is controlled in accordance with the desired primary function of the circuit 10, such as for battery charging and/or output voltage regulation.

With the above configuration, the decoupling capacitor connection 18 is buffered from the supply input connection 16 via the high-impedance current path included in the parallel pair of current paths. Since the low impedance path is not enabled upon startup, the decoupling capacitor, C_IN, which is associated with the decoupling capacitor connection 18, is gradually charged through the high impedance path of circuit path 20, and high inrush currents are avoided.

More particularly, the exemplary current path through D1/Q1 is a passively-enabled, high-impedance current path that is “on” at startup by default. With that configuration, a relatively low current, I_{SU}, begins flowing into the startup control circuit 14 and into the decoupling capacitor C_IN, upon the application of a sufficient supply voltage to the supply input connection 16. In one embodiment, Q1 is a P-channel Field Effect Transistor (FET) device, and startup control circuit 14 is configured to hold the gate of Q1 low at least during startup, such that Q1 turns on once sufficient gate-to-source voltage is developed. In the illustrated configuration, the gate-to-source voltage of Q1 generally is the applied input voltage, VIN, minus the forward voltage drop of diode D1. Thus, Q1 can be made to turn on with the application of voltage to the supply input connection 16.

Once the startup control circuit 14 detects that capacitor C_IN has charged to a desired level, it asserts one or more control signals that, in an exemplary embodiment, enable the high-side regulator 30 and the core 32. High-side regulator 30 begins generating a high-side gate drive signal for Q2, which may be a N-channel FET that turns on at a defined gate-to-source voltage. Because the source of Q2 is at the same voltage as the internal power bus (“SYSTEM NODE”) interconnecting the various sub-circuits, Q2 turns on and begins drawing operating current, I_{OP}, only after the high-side regulator 30 begins generating a voltage sufficiently higher than that bus's voltage. Because of this configuration, the low-impedance current path through Q2 inherently is disabled at startup and requires selective activation by the startup control circuit 14 via high-side regulator 30. Note that high-side regulator 30 may be a charge-pump circuit by way of non-limiting example.

Once the low-impedance current path in current path 20 is enabled, the voltage regulating circuit 10 can begin its intended, primary operations. Thus, startup control circuit 14 may be configured to bring the core 32 out of reset as part of transitioning from the startup condition into a “run” condition. Core 32 is configured according to the desired functionality of the voltage regulating circuit 10 and, by way of non-limiting example, it may include output voltage regulation logic, such that it controls output regulator 34 to vary the gate drive of pass transistor Q3, so that the output voltage, VOUT, is maintained at a desired level.

Whatever its intended function, core 32 typically includes at least some digital logic and/or memory, such as timer/counter registers, and other digital circuit elements that are used in the primary operating function. It is an advantage therefore of the present invention to provide a small current to such circuits via the passively-enabled high-impedance current path of current path 20, even if the low-impedance current path is not actively enabled. That is, the control state and/or memory contents of circuits within the core 32 can be maintained by a “trickle” current through D1/Q1 during times that Q2 is turned off (assuming, of course, that sufficient voltage is present on the supply input connection 16).

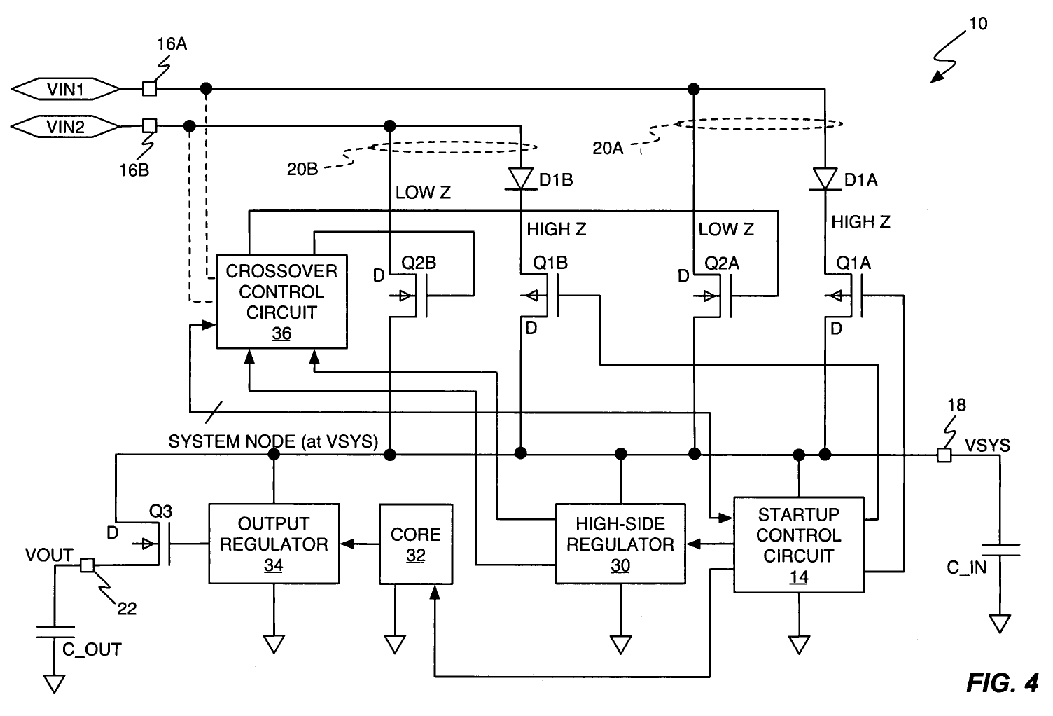

FIG. 4 extends the operational concept of FIG. 3 by providing two supply input connections 16A and 16B, to which different voltage supplies, VIN1 and VIN2, are respectively connected. The advantage of providing two or more supply input connections for circuit 10 includes the ability to “hot swap” voltage supplies, and to make “best of” or “preferred” voltage supply selections from among the available input connections.

In such contexts, a “preferred” voltage supply may be the one connected to the supply input connection considered to be the default input by the voltage regulating circuit 10. Similarly, the “best” voltage supply may be the one having the highest voltage, or the voltage that most closely matches the nominal input supply voltage ratings, etc. It should be understood that circuit 10 preferably includes voltage references, such as band gap voltage references, and comparators, that it uses to make any needed voltage comparisons. Further, it should be understood that the selection between available input supply connections may be made according to a fixed preference, such as a supply input preference ranking. Where two or more supply connections have satisfactory supply voltage applied to them—i.e., a voltage within defined operating range limitations—the circuit 10 can select the particular supply connection to use based on a default preference.

Returning to the illustration, circuit features common to FIGS. 3 and 4 generally function the same and discussion of their operation need not be repeated. Of more interest are the added circuit features shown in FIG. 4, which include a crossover switching control circuit 36 that is configured to provide supply input selection processing, and the dual current paths 20A and 20B, each configurable for operation in a high or low-impedance condition. Current path 20A includes a passively-enabled, high-impedance path through D1A/Q1A, and an actively-enabled, low-impedance path through Q2A. Similarly, current path 20B includes a passively-enabled, high-impedance path through D1B/Q1B, and an actively-enabled, low-impedance path through Q2B.

With the above configuration, when circuit 10 is “hot-switched” from one supply to the other, the crossover switching control circuit 36 provides a mechanism to maintain the output signal at output connection 22 during the crossover operation, and to maintain the logic state of core 32. Thus, the “glitches” in VOUT and/or the risk of unintended reset of the core 32 when switching from one supply input connection to the other are eliminated or at least greatly reduced by the present invention's crossover control apparatus and method.

In at least one embodiment, the crossover switching control circuit 36 isolates the gate drive of the transistor device that is presently providing the low-impedance supply path (i.e. either Q2A or Q2B) without discharging its gate capacitance. In that state, the isolated transistor device allows operating current to pass, thereby sustaining the supply rail. Crossover switching control circuit 36 then energizes the gate of the transistor device that will provide the low-impedance path for the input supply that is being switched on. After the crossover switching control circuit 36 determines that the new power path is on sufficiently, it then discharges the previously isolated device gate to open the low-impedance current path provided by it and thereby prevent unwanted feed through currents between the different supplies.

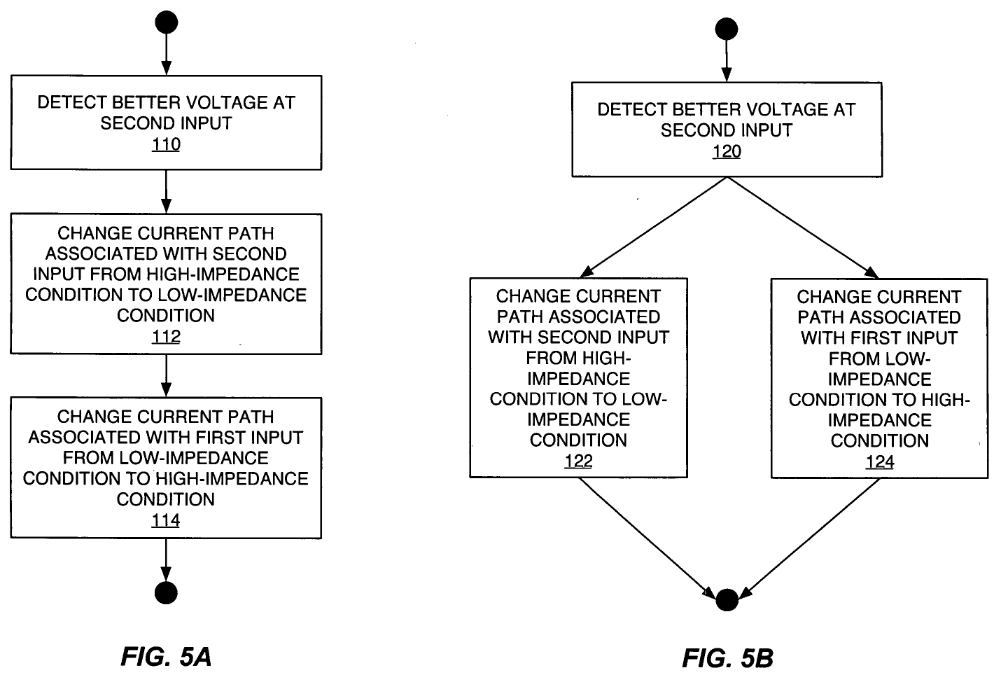

In stepping through an example of crossover switching, FIGS. 5A and 5B illustrate two similar embodiments of processing/control logic that can be implemented in the voltage regulating circuit 10. As context for the illustrated processing, one should assume that a sufficient supply voltage is applied to a first supply input connection, e.g., input connection 16A, and that no voltage is yet applied to a second supply input connection, e.g., supply input connection 16B.

Upon first application of supply voltage to input connection 16A, and assuming that C_IN was discharged, Q1A turns on by default, and charging current for C_IN begins flowing through the Q1A path of current path 20A, while Q2A remains turned off. Note that the primary operating circuits 12 (e.g., core 32, etc.) remain off or otherwise disabled, and that the output pass transistor device Q3 generally remains off during the startup phase during which C_IN is allowed to charge to a desired voltage level.

At some later point, the voltage (VSYS) on C_IN reaches a defined threshold voltage at which C_IN is considered sufficiently charged to enable Q2A. Startup control circuit activates high-side regulator 30, which provides a gate drive signal to crossover switching control circuit 36 for activation of transistor device Q2A of current path 20A. Crossover switching control circuit 36 passes that gate drive signal through, thereby turning on transistor device Q2A and enabling a low-impedance current path through which primary operating current for circuit 10 flows. As part of this transition from startup condition to run condition, startup control circuit 14 may bring core 32 out of reset, so that circuit 10 begins its primary operations.

Thus, processing in the context of FIG. 5A begins with the voltage regulating circuit 10 in a run condition, wherein it is carrying out its primary operations, such as carrying out battery charging functions, and is being powered by the voltage supply (VIN1) coupled to supply input connection 16A. Note that with transistor device Q2B turned off, and with diode D1B in a reverse blocking configuration, there is no current flow from supply input connection 16A to supply input connection 16B (i.e., from VIN1 to VIN2) even if an inactive voltage supply is coupled to supply input connection 16B.

At some point during the above circumstances, circuit 10 detects a better voltage at its second supply input connection 16B (Step 110), or otherwise decides to change from supply input connection 16A to 16B, and undertakes supply crossover switching such that it stops sourcing its operating current from VIN1 and begins sourcing its operating current from VIN2. Crossover switching control circuit 36 is configured to ensure that the switchover from VIN1 to VIN2 does not interrupt operation of circuit 10.

In carrying out the above crossover operation, crossover switching control circuit 36 changes current path 20B from a high-impedance condition to a low-impedance condition by enabling transistor device Q2B (Step 112). Once transistor device Q2B is turned on sufficiently to ensure adequate operating current through current path 20B which may be qualified by timing, current sensing, etc., crossover switching control circuit 36 changes current path 20A from a low-impedance condition to a high-impedance condition by disabling transistor device Q2A (Step 114). At that point, reverse current flow from VIN2 to VIN1 through the current path 20A is blocked by the disabled transistor device Q2A and the reverse blocking diode D1A.

Of course, it should be understood that, while the above processing/control logic implies a sequential enabling of a low-impedance connection through current path 20B and a subsequent disabling of a low-impedance connection through current path 20A, the crossover switching control circuit 36 can be configured to carry out a simultaneous crossover control operation, such as is illustrated in FIG. 5B. The actual processing in FIG. 5B essentially is the same as shown in FIG. 5A, except that it makes explicit the possibility that crossover switching control circuit 36 turns on the low-impedance connection in one of current paths 20A and 20B as it turns off the low-impedance connection in the other one of current paths 20A and 20B.

For example, as Q2B is being turned on to enable a low-impedance connection to VIN2 through current path 20B, Q2A is being turned off to disable the low-impedance connection to VIN1 through current path 20A. The advantage of coordinating overlapping turn-on and turn-off operations in this manner is that continuity of primary operating current flow into circuit 10 can be ensured, while simultaneously minimizing the possibility of undesirable reverse current flow between voltage supplies.

Thus, it should be understood that crossover switching control circuit 36, or startup control circuit 14, or some other circuit element within the voltage regulating circuit 10, can be configured with analog or digital timing circuits and/or voltage or current sensing circuits, that are used for controlling the switchover between a currently selected voltage supply and a newly selected voltage supply. Further, it should be understood that crossover switching control circuit 36, or some other circuit in voltage regulating circuit 10, can be configured with voltage detection circuits, possibly isolated, to detect the presence of voltages at each of two or more supply input connections 16. Such detection can be based on sensing the actual value of applied voltage, or by detecting that the applied voltage is above a defined threshold, or within a defined operating range. Voltage detection thus can serve as a trigger for supply switchover.

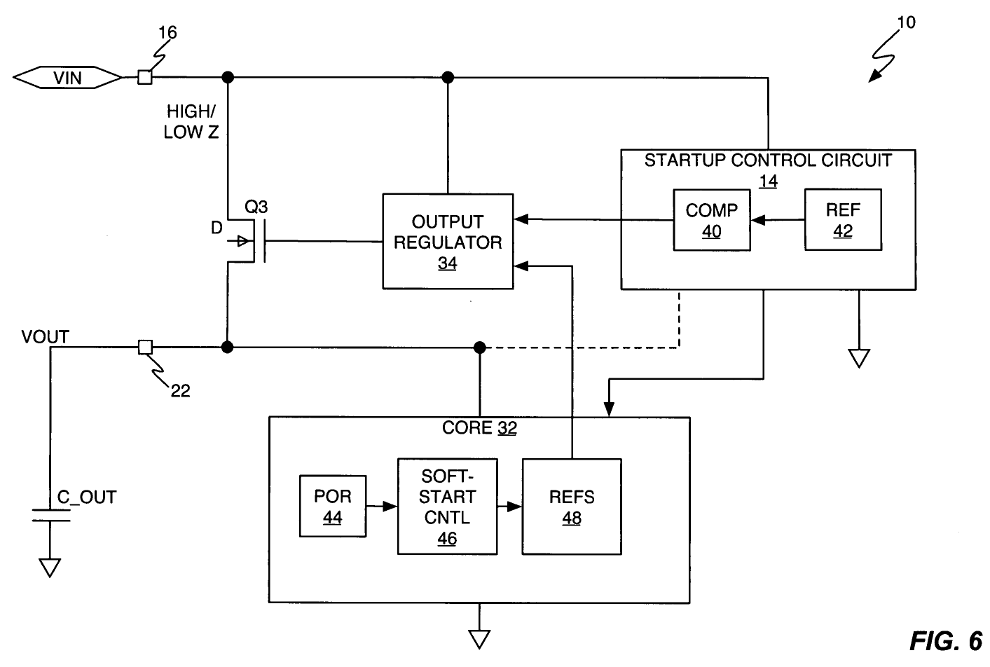

FIGS. 5A and 5B thus disclose advantageous embodiments regarding crossover switching. However, additional advantageous variations are contemplated by the present invention without regard to whether crossover switching control is included. For example, FIG. 6 illustrates an embodiment wherein an output capacitor, C_OUT, is put the dual purpose of output signal filtering and input supply decoupling. That is, the output capacitor C_OUT also serves as the supply input decoupling capacitor, thus eliminating the need for a separate input decoupling capacitor, C_IN, as was used in FIG. 4, for example. The use of COUT as the input supply decoupling capacitor can apply to single-input and multiple-input embodiments of the circuit 10.

For any such embodiments, startup control circuit 14 preferably includes comparator circuit 40, and a reference circuit 42, which may be a relatively crude and inexpensive voltage reference, and may further include whatever filtering and clamping is needed at its supply input to offer good Power Supply Ripple Rejection Ratio (PSRR) and voltage robustness. By powering startup control circuit 14 directly from the input voltage supply, startup control circuit 14 can be made to control output regulator 34 such that the pass transistor device Q3 is slightly turned on initially, such that the voltage regulating circuit 10 soft start starts if C_OUT is discharged. That is, startup control circuit 14 controls the drain-to-source on resistance (RDSON) responsive to detecting the charge on C_OUT, such that Q3 acts as a voltage-controlled variable resistive circuit device that has a high impedance if C_OUT is discharged—i.e., if the voltage at the output connection 22 is below a defined voltage comparison threshold known to startup control circuit 14.

In its high-impedance condition, then, Q3 provides capacitor C_OUT with a fixed charging current, which is set at a magnitude sufficient to prevent high inrush currents and input voltage ringing, but which allows C_OUT to charge at a desired rate for a given C_OUT capacitance.

The illustrated core 32 comprises a Power-On-Reset (POR) circuit 44, a soft-start control circuit 46, and one or more voltage references 48, and POR circuit 44 can be configured to monitor the voltage level on the C_OUT node, and provide a start signal to activate core 32 responsive to detecting that that voltage has risen to a sufficient level. Alternatively, reset control signaling can be provided by startup control circuit 14 responsive to detecting the C_OUT voltage level. After the core 32 is enabled via such signaling, soft-start control circuit 46 may be configured to provide a soft-start sequence for transitioning circuit 10 from its startup mode to its normal run mode, wherein it carries out its primary operations, such as battery charging.

In the above configuration, it is advantageous to configure the output regulator 34 and the startup control circuit 14 to have a high PSRR, since these blocks directly “see” the voltage applied to the supply input connection 16. As noted previously, these same circuit blocks also should be robust in terms of input voltage ratings for the same reasons.

From the details immediately above, and from the earlier details given herein, one sees that the present invention can be implemented in a number of different ways, such as by configuring the output capacitor also to provide input supply decoupling, and/or by configuring the circuit 10 to provide crossover switching control between two or more supply input connections. Regardless, those skilled in the art should recognize that the present invention broadly contemplates a voltage regulating circuit having inrush current limiting based on buffering the circuit's decoupling capacitor through a current path that is selectively configured to have a high impedance for startup charging of the decoupling capacitor, and a low impedance for normal operations of the circuit. As such, the present invention is not limited by the foregoing details, but rather is limited only by the following claims and their reasonable equivalents.

What is claimed is:

1. A method of limiting inrush current into a voltage regulating circuit comprising:
coupling a supply input connection of the voltage regulating circuit to a decoupling capacitor connection of the voltage regulating circuit through a current path that is selectively changeable from a high-impedance condition to a low-impedance condition; and
selectively changing the current path from its high-impedance condition to its low-impedance condition.

2. The method of claim 1, wherein selectively changing the current path from its high-impedance condition to its low-impedance condition comprises changing the current path to its low-impedance condition responsive to detecting that a voltage on the decoupling capacitor connection is above a defined voltage threshold.

3. A method of limiting inrush current into a voltage regulating circuit comprising buffering a decoupling capacitor connection of the voltage regulating circuit from a supply input connection of the voltage regulating circuit through a current path that is selectively changeable from a high-impedance condition to a low-impedance condition responsive to determining whether a decoupling capacitor associated with the decoupling capacitor connection is charged.

4. The method of claim 3, wherein the current path includes a variable resistance circuit device, and wherein the current path is selectively changeable from a high-impedance condition to a low-impedance condition by controlling the circuit device to have a relatively high resistance or a relatively low resistance.

5. The method of claim 3, wherein the current path comprises a parallel pair of current paths comprising a high-impedance current path and a low-impedance current path, and wherein the current path is selectively changeable from a high-impedance condition to a low-impedance condition by selectively enabling the low-impedance current path.

6. The method of claim 5, further comprising configuring the high-impedance current path to be passively enabled, such that the associated decoupling capacitor is initially charged through the high-impedance current path responsive to the application of supply voltage to the supply input connection, and configuring the low-impedance current path to be actively enabled, such that the low-impedance current path is selectively turned on after the associated decoupling capacitor reaches a desired charging level.

7. The method of claim 5, further comprising selectively enabling the low-impedance current path responsive to monitoring a voltage of the associated decoupling capacitor.

8. The method of claim 5, further comprising selectively enabling the low-impedance current path responsive to detecting whether the associated decoupling capacitor is charged.

9. The method of claim 3, further comprising buffering a second supply input connection from the decoupling capacitor connection through a second current path that is selectively changeable from a high-impedance condition to a low-impedance condition responsive to determining whether a decoupling capacitor associated with the decoupling capacitor connection is charged.

10. The method of claim 9, further comprising selectively changing from a currently selected one of the first and second supply input connections to a newly selected one of the first and second supply input connections based on placing the current path corresponding to the newly selected supply input connection in a low-impedance condition before placing the current path corresponding to the currently selected supply input connection in a high-impedance condition.

11. The method of claim 9, further comprising selectively changing from a currently selected one of the first and second supply input connections to a newly selected one of the first and second supply input connections based on placing the currently selected supply input connection in a high-impedance condition before placing the current path corresponding to the newly selected supply input connection in a low-impedance condition.

12. The method of claim 3, further comprising configuring the decoupling capacitor connection as the output connection of the voltage regulating circuit, such that an output capacitor for the voltage regulating circuit serves as the decoupling capacitor for the supply input connection of the voltage regulating circuit.

13. The method of claim 3, further comprising configuring the voltage regulating circuit to include a startup control circuit operable from a low current obtained through the current path in its high-impedance condition, and a primary operating circuit operable from a relatively higher current obtained through the current path in its low-impedance condition.

14. The method of claim 13, further comprising configuring the startup control circuit to control the current path to change from the high-impedance condition to the low-impedance condition responsive to detecting whether the decoupling capacitor is charged.

15. The method of claim 13, further comprising configuring the startup control circuit to enable and disable the primary operating circuit responsive to detecting whether the decoupling capacitor is charged.

16. The method of claim 3, wherein the voltage regulating circuit comprises one of a battery charging circuit and a voltage regulator circuit.

17. A voltage regulating circuit configured to limit inrush current and comprising:
a supply input connection configured to connect with a voltage supply;
a decoupling capacitor connection configured to connect with an associated decoupling capacitor;
a current path configured to buffer the decoupling capacitor connection from the supply input connection, said current path configured to be selectively changeable from a high-impedance condition to a low-impedance condition responsive to determining whether the decoupling capacitor is charged.

18. The voltage regulating circuit of claim 17, wherein the current path includes a variable resistance circuit device, such that the current path is selectively changeable from a high-impedance condition to a low-impedance condition by controlling the variable resistance circuit device to have a high resistance or a low resistance.

19. The voltage regulating circuit of claim 18, further comprising a startup control circuit configured to control the variable resistance device responsive to detecting a charging level of the decoupling capacitor.

20. The voltage regulating circuit of claim 17, wherein the current path comprises a parallel pair of current paths comprising a high-impedance current path configured to provide a low current for initially charging the decoupling capacitor, and a low-impedance current path configured to provide a relatively higher current for powering a primary operating circuit of the voltage regulating circuit after the decoupling capacitor reaches a desired charging level.

21. The voltage regulating circuit of claim 17, wherein the current path comprises a parallel pair of current paths comprising a high-impedance current path that is configured to be passively enabled upon the application of a supply voltage to the supply input connection, thereby allowing the decoupling capacitor to be initially charged at a low current, and a low-impedance current path that is configured to be actively enabled, thereby allowing the low-impedance current path to be selectively turned on after the decoupling capacitor reaches a desired charging level.

22. The voltage regulating circuit of claim 21, further comprising a startup control circuit to detect the charging level of the decoupling capacitor and selectively enable the low-impedance current path responsive thereto.

23. The voltage regulating circuit of claim 17, further comprising a second current path buffering a second supply input connection of the voltage regulating circuit from the decoupling capacitor connection, and wherein the second current path is configured to be selectively changeable from a high-impedance condition to a low-impedance condition.

24. The voltage regulating circuit of claim 23, further comprising a crossover switching control circuit configured selectively to switch between the first and second supply input connections by controlling the high-impedance and low-impedance conditions of the first and second current paths.

25. The voltage regulating circuit of claim 24, wherein the crossover switching control circuit is configured to switch from a currently selected one of the first and second supply input connections to a newly selected one of the first and second supply input connections by placing the current path corresponding to the newly selected supply input connection in a low-impedance condition, and then placing the current path corresponding to the currently selected supply input connection in a high-impedance condition.

26. The voltage regulating circuit of claim 24, wherein the voltage regulating circuit is configured to select the supply input connection having the highest supply voltage applied to it.

27. The voltage regulating circuit of claim 24, wherein the voltage regulating circuit is configured to select between the first and second supply input connections according to a fixed preference, at least under circumstances where both the first and second supply input connections have satisfactory supply voltages applied to them.

28. The voltage regulating circuit of claim 17, wherein the current path comprises a passively-enabled, high-impedance current path to provide initial low-current charging of the associated decoupling capacitor, and an actively-enabled, low-impedance current path to provide operating current to the voltage regulating circuit.

29. The voltage regulating circuit of claim 28, further comprising a startup control circuit configured to enable the actively-enabled, low-impedance current path responsive to detecting a voltage of the decoupling capacitor.

30. The voltage regulating circuit of claim 17, wherein the decoupling capacitor connection also comprises an output connection of the voltage regulating circuit, such that an output capacitor of the voltage regulating circuit also serves as the decoupling capacitor of the voltage regulating circuit.

31. The voltage regulating circuit of claim 17, wherein the voltage regulating circuit includes a startup control circuit operable from a low current obtained through the current path when the current path is in a high-impedance condition, and includes a primary operating circuit operable from a relatively higher current obtained through the current path when the current path is in a low-impedance condition.

32. The voltage regulating circuit of claim 31, wherein the startup control circuit is configured to enable and disable the primary operating circuit responsive to detecting whether the associated decoupling capacitor is charged.

33. A voltage regulating circuit including a supply input connection coupled to a decoupling capacitor connection through a current path that is configured to be selectively changeable from a high-impedance condition to a low-impedance condition, and including a startup control circuit configured to change the current path from the high-impedance condition to the low-impedance condition responsive to detecting that a decoupling capacitor associated with the decoupling capacitor connection has reached a desired charging level.
